(19) United States
(12) Patent Application Publication
(10) Pub. No.: US 2005/0156560 A1
(43) Pub. Date: Jul. 21, 2005

(54) Charging apparatus by non-contact dielectric feeding

(76) Inventors: Motohiro Shimaoka, Tokyo (JP); Hiroki Hirashima, Tokyo (JP); Yasuo Kondo, Tokyo (JP)

Correspondence Address: Brinks Hofer;Gilson & Lione, PO Box 10395, Chicago, IL, 60610, US

(21) Appl. No.: 10/511,239

(22) PCT Filed: Apr. 4, 2003
(86) PCT No.: PCT/JP03/04346

(30) Foreign Application Priority Data
Apr. 8, 2002 (JP) 2002-105869

(51) Int. Cl. H02J 7/00

(52) U.S. Cl. 320/107

(57) ABSTRACT

A plurality of chargers 7 are provided in a housing 2, these chargers 7 noncontactly supply electric power to the objects W by electromagnetic induction. Each of the objects W includes an IC chip 80 having a high-frequency oscillator circuit and an antenna 90 connecting to the IC chip. The charging apparatus 1 further includes an antenna 110 for receiving high-frequency data signals from the IC chip 80 and a circuit for controlling the chargers 7 around the object W according to the data signals received by the antenna 110 so as to drive a charger 7 sending electromagnetic waves to the object from an optimal direction.

### TECHNICAL FIELD

The present invention relates to charging apparatuses for enabling a plurality of objects such as secondary batteries to be easily charged.

### BACKGROUND ART

Recently, portable information equipment such as cellular phones has been developed, and a variety of compact electronics including secondary batteries as power sources are manufactured for commercial use. Such electronics employ a charging method whereby AC adapters, i.e. battery chargers, charge secondary batteries of the electronics from home power sources through charging circuits built in the electronics.

There is a large variety in types of such secondary batteries, therefore, various AC adapters are exclusively required for their respective electronics, in other words, there are a large number of AC adapters in the home. This is wasteful.

It is an object of the present invention to provide a charging apparatus enabling a variety of objects such as secondary batteries to be easily charged by merely receiving multiple objects in the housing and to replace many chargers with the charging apparatus.

### DISCLOSURE OF INVENTION

A charging apparatus according to the present invention includes a housing which is a case having an opening at one side, an openable supported door for shutting the opening of the housing, and chargers for charging at least one object to be charged in the housing. The charger noncontactly supplies electric power by electromagnetic induction from a built-in coil of a power feeder to the object having a built-in coil of a power receiver and a built-in battery.

Since such a charging apparatus can easily charge a plurality of objects such as various secondary batteries by merely receiving them in the housing, many chargers exclusively used to change secondary batteries for a variety of electronic devices are not needed. Consequently, the number of dedicated chargers is drastically decreased. Therefore, the charging apparatus according to the present invention is very valuable from the recent controversial viewpoint of using resources effectively.

The object includes an integrated circuit (IC) chip having a high-frequency oscillator circuit and an antenna connecting to the IC chip. The charging apparatus according to the present invention includes an antenna for receiving high-frequency data signals sent from the IC chip through the antenna and a circuit for controlling the chargers around the object according to the data signals received by the antenna so as to drive a charger sending electromagnetic waves to the object from an optimal direction.

Since such a charging apparatus drives and controls a charger among the chargers around the object which sends electromagnetic waves to the object from an optimal direction regardless of the position of the object, the charger can efficiently charge the object by electromagnetic induction. The charging apparatus can easily charge a plurality of objects such as various secondary batteries by merely receiving them in the housing. Consequently, many chargers exclusively used to charge secondary batteries for a variety of electronic devices are not needed and the number of dedicated chargers is drastically decreased. Therefore, the charging apparatus according to the present invention is very valuable from the recent controversial viewpoint of using resources effectively.

The charging apparatus according to the present invention includes at least one shelf in the housing for receiving the object. The chargers may be provided to the shelf and/or the housing for charging the object placed on the shelf and/or on the inner face of the bottom of the housing.

Since such a charging apparatus can retain spaces for receiving the object in the housing, a larger number of the objects can be charged.

The charging apparatus according to the present invention may have at least one standing partition on said at least one shelf and/or on the inner face of the bottom of the housing for partitioning the shelf and/or the inner face of the bottom of the housing into a plurality of spaces so that the object can be placed at the space partitioned by the partition.

Since such a charging apparatus can retain spaces for receiving the object in the housing, a larger number of the objects can be charged.

In the charging apparatus according to the present invention, the partition may be provided with the chargers.

In such a charging apparatus, since the chargers are arranged close to the side face of the object, it is useful for charging at high speed.

From this viewpoint, all of the partitions may be provided with the chargers, or some of the partitions may be provided with the chargers so that the spaces surrounded by the partitions with the chargers may be used for the high-speed charging.

In the charging apparatus according to the present invention, the housing preferably includes a shielding body for shielding the outside from electromagnetic waves generated by the electromagnetic induction.

The shielding body can protect other electronic devices nearby the charging apparatus from adverse effects of electromagnetic waves generated in the charging apparatus.

In the charging apparatus according to the present invention, said at least one shelf may have a shielding body for blocking electromagnetic waves generated by the electromagnetic induction below the shelf.

The shielding body can block the electromagnetic waves from below the shelf.

In the charging apparatus according to the present invention, said at least one partition may have a shielding body for blocking electromagnetic waves generated by the electromagnetic induction.

The shielding body can block the electromagnetic waves from the spaces adjacent to the space surrounded by the partitions.

The object used in the charging apparatus according to the present invention may include a secondary battery detached from an electronic device and an adapter having a built-in coil of a power receiver and attached to the secondary battery. Preferably, the adapter is detachable from various secondary batteries. The object may be a secondary battery detachable from an electronic device and have a coil of a power receiver.

By using such objects the charging apparatus itself according to the present invention can be downsized.

The object may be a portable electronic device instead of a combination of the secondary battery and the adapter. In such a case, in order to eliminate the adverse effects of electromagnetic waves on the portable electronic device, preferably, only a portion, where the coil of the power receiver is disposed, of the electronic device is exposed and the remaining portions are covered with a shielding body.

### BRIEF DESCRIPTION OF THE DRAWINGS

FIG. 1 is a perspective view of a charging apparatus according to a first embodiment of the present invention.

FIG. 2 is an elevation view of the charging apparatus shown in FIG. 1, upon a door being opened.

FIG. 3 is an enlarged perspective view illustrating the shelf and the partitions shown in FIG. 2.

FIG. 4 is a circuit diagram illustrating the charger and the object to be charged shown in FIG. 2.

FIG. 5 is a perspective view of an object that is provided with a rectangular board having a high-frequency IC chip and an antenna and that is used with a charging apparatus according to a second embodiment of the present invention.

FIG. 6 is an enlarged perspective view of the rectangular board having the high-frequency IC chip and the antenna shown in FIG. 5.

FIG. 7 is an enlarged perspective view of a circular board having the high-frequency IC chip and the antenna, different from the board shown in FIG. 6.

FIG. 8 is a layout outline illustrating the IC chip and the antenna, and the antenna and the control circuit shown in FIGS. 6 and 7.

FIG. 9 is a perspective view illustrating a shelf and partitions in a charging apparatus according to a third embodiment of the present invention.

FIG. 10 is a perspective view illustrating an underneath of a charging apparatus according to a fourth embodiment of the present invention.

FIG. 11 is a perspective view illustrating a charging apparatus according to a fifth embodiment of the present invention.

FIG. 12 is a perspective view of the housing of the charging apparatus shown in FIG. 11, upon a door being opened.

FIG. 13 is a perspective view illustrating a charging apparatus according to a sixth embodiment of the present invention.

FIG. 14 is a perspective view of the housing of the charging apparatus shown in FIG. 13, upon a door being opened.

FIG. 15 is a perspective view illustrating a charging apparatus according to a seventh embodiment of the present invention.

FIG. 16 is a perspective view of the housing of the charging apparatus shown in FIG. 15, upon a door being opened.

### BEST MODE FOR CARRYING OUT THE INVENTION

The embodiments according to the present invention will now be described with reference to the drawings.

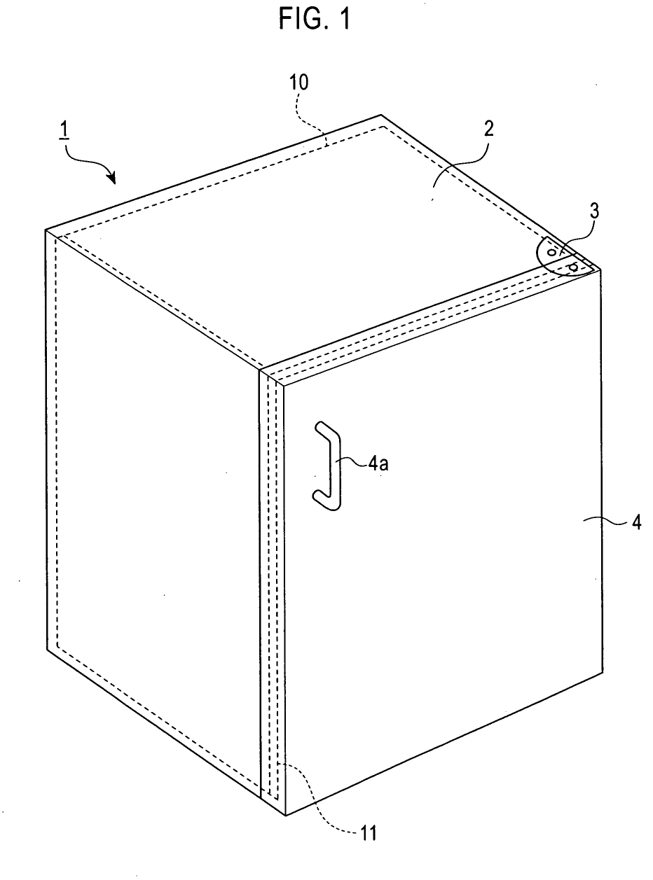

FIGS. 1 to 4 illustrate a first embodiment of the present invention. As shown in FIG. 1, a charging apparatus 1 includes a housing 2 which is a case having an opening at the front and an openable door 4 supported by hinges 3 to shut the opening of the housing 2. The door 4 is provided with a door handle 4a.

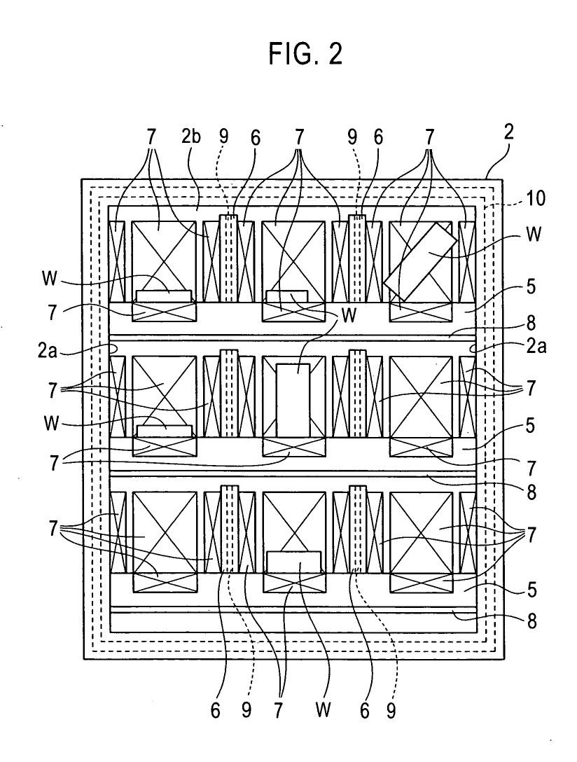

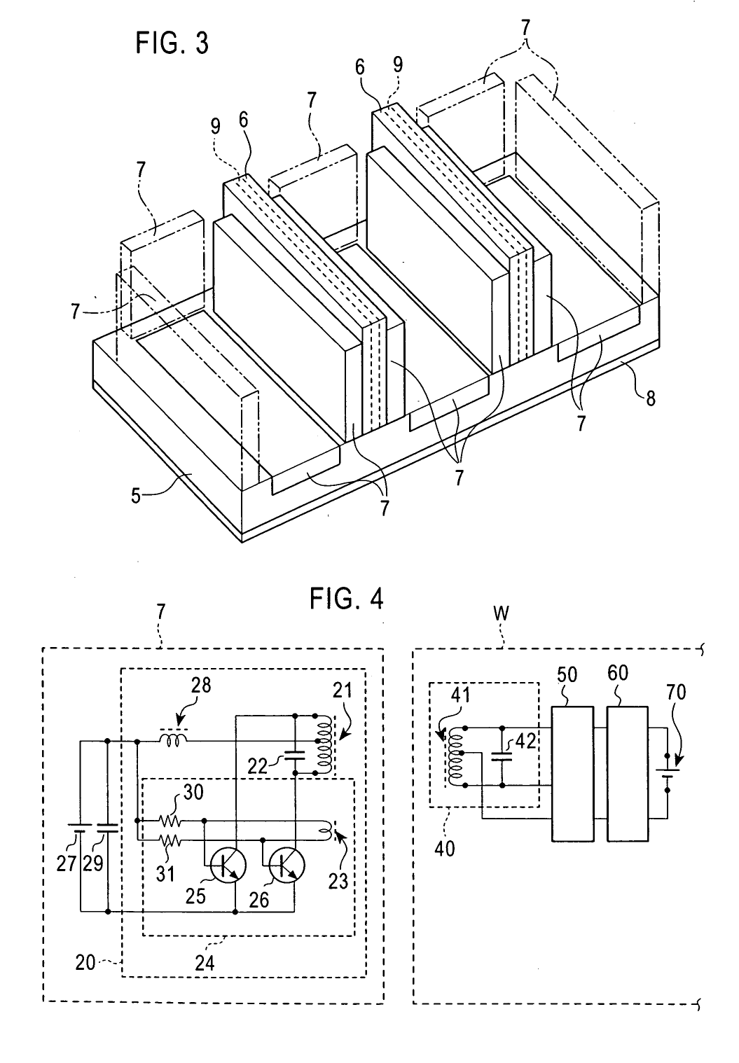

As shown in FIGS. 2 and 3, the housing 2 has three shelves 5 for receiving various types of objects W to be charged. Each shelf 5 is partitioned by a plurality of standing partitions 6 in the lateral direction, and the various types of objects W are put in spaces partitioned by the partitions 6. In the housing 2, chargers 7 are provided in these shelves 5 and on the inner faces of side walls 2a, the inner face of a back wall 2b, and the partitions 6. The chargers 7 surround the objects W put on the shelves 5 to charge the objects. In FIG. 3, the chargers 7 shown by two-dot chain lines are mounted on the inner faces of the side walls 2a and the inner face of the back wall 2b.

The shelves 5 and the partitions 6 are provided with shielding bodies 8 and 9, respectively. The shielding bodies 9 are embedded in the partitions 6. The shielding bodies eliminate harmful effects of electromagnetic waves generated by chargers 7 below the shelves 5 and chargers 7 in the spaces partitioned by the partitions 6.

As shown in FIGS. 1 and 2, the housing 2 and the door 4 are provided with shielding bodies 10 and 11, respectively. These shielding bodies are embedded in the housing 2 and the door 4 and enclose the interior space formed by the housing 2 and the door 4 so that the electromagnetic waves generated by the chargers 7 mounted in the housing 2 and the shelves 5 and on the partitions 6 do not adversely affect the outside of the charging apparatus 1.

The object W may include a secondary battery which is detached from an electronic device such as portable electronic devices and an adapter attached to the secondary battery and having a coil of a power receiver. The adapter is adjustable to various types of secondary batteries.

The object W may be a portable electronic device itself. In such a case, in order to eliminate the adverse effects of electromagnetic waves on the portable electronic device, only the portion, where the coil of the power receiver is disposed, of the electronic device is exposed and the remaining portion is covered with a shielding body.

The chargers 7 noncontactly supply electric power from resonance coils of power feeders to resonance coils of the power receivers by electromagnetic induction, regardless of the type of the batteries in the objects W. For example, as shown in FIG. 4, each of the chargers 7 includes an oscillator circuit 20 for the power feeder including the resonance coil 21 of the power feeder and a resonance capacitor 22 connected in parallel to the resonance coil 21. When the object W is a portable electronic device, the device includes an oscillator circuit 40 for the power receiver, a rectifier/smoothing circuit 50, and a charge control circuit 60. When the object W is a combination of an adapter and a secondary battery, the adapter includes the oscillator circuit 40 for the power receiver, the rectifier/smoothing circuit 50, and the charge control circuit 60. The oscillator circuit 40 includes a resonance coil 41 of the power receiver and a resonance capacitor 42 connected in parallel to the resonance coil 41. The charger 7 is equipped with a detector coil 23 for detecting induced electromotive force occurring due to a flux from both the coil 21 of the power feeder and the coil 41 of the power receiver, and a control circuit 24 for tuning an oscillation frequency for the power feeder to a resonance frequency for the power receiver by changing the power applied to the coil 21 of the power feeder according to a frequency of the induced electromotive force detected by the detector coil 23.

The control circuit 24 has a first transistor 25 and a second transistor 26 that supply reverse currents to the coil 21 of the power feeder. The first transistor 25 and the second transistor 26 are switched so as to alternately supply the current to the coil 21 of the power feeder according to a change in polarity of the induced electromotive force detected by the detector coil 23. A DC power source 27 for the power feeder supplies current to the coil 21 of the power feeder in alternate reverse directions by switching the first transistor 25 and the second transistor 26. The first transistor 25 and the second transistor 26 have different current gains. Upon DC voltage being applied to the first transistor 25 and the second transistor 26, a transistor having a higher current gain supplies the current to the coil 21 of the power feeder to start the oscillation.

The direct current of the DC power source 27 may be direct current converted from general alternate current for household or business purposes.

In FIG. 4, a coil 28 resides between the DC power source 27 and a neutral point of the coil 21 of the power feeder, a capacitor 29 is connected in parallel to the top point and the bottom point of the coil 21 of the power feeder, and resistors 30 and 31 form the control circuit 24. The resistor 30 resides between the base of the first transistor 25 and the positive electrode of the DC power source 27, and the resistor 31 resides between the base of the second transistor 26 and the positive electrode of the DC power source 27. In FIG. 4, reference numeral 70 represents a secondary battery.

Then, a process for charging objects will be described according to the first embodiment of the present invention.

When a portable electronic device is equipped with the oscillator circuit 40 for the power receiver, a rectifier/smoothing circuit 50, and a current control circuit 60 shown in FIG. 4, the door 4 is opened, and then the portable electronic device, as an object W to be charged, is put on an arbitrary shelf 5 divided by partitions 6 in the housing 2. When the object W is put on the shelf 5, the four chargers 7 arranged under, at both sides of, and behind the object W generate resonance frequencies for the object W from the resonance coil 21 of the power feeder shown in FIG. 4. The resonance coil 41 of the power receiver of the object W tunes to a resonance frequency from an optimal direction among these resonance frequencies, and receives electromagnetic energy in cooperation with the resonance capacitor 42, and then converts it into DC electrical energy. Such voltage is rectified and smoothed by the rectifier/smoothing circuit 50, is adjusted to a voltage suitable for charging by the charge control circuit 60, and then is sent to the secondary battery 70 to charge the secondary battery 70.

When a secondary battery detached from an electronic device such as portable electronic devices is charged, an adapter including the oscillator circuit 40 for the power receiver, the rectifier/smoothing circuit 50, and the current control circuit 60 shown in FIG. 4 is attached to the secondary battery. The door is opened, and then the secondary battery provided with the adapter, as an object W to be charged, is put on arbitrary shelf 5 divided by partitions 6 in the housing 2. Then, the secondary battery is charged according to the above-described process.

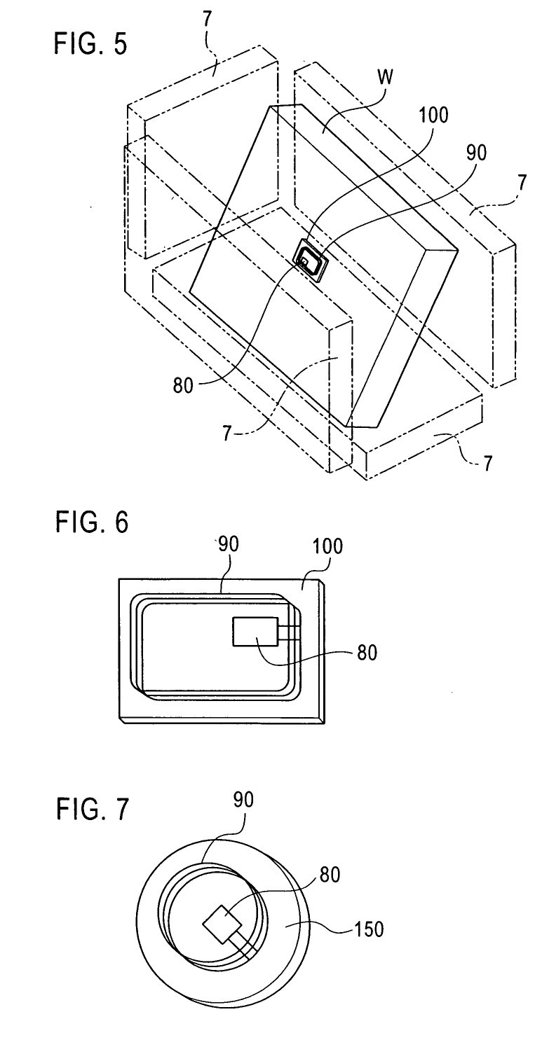

A charging apparatus according to a second embodiment of the present invention will be described with reference to FIGS. 5 to 8.

In the charging apparatus in the second embodiment, the object W in the first embodiment shown in FIGS. 1 to 4 is provided with a high frequency IC chip and an antenna. Members being the same as those shown in FIGS. 1 to 4 are referred to with the same reference numerals and the description thereof is omitted.

As shown in FIGS. 5 to 7, the object W is provided with a rectangular board 100 including the IC chip 80 and the loop-antenna 90. The IC chip 80 has a high-frequency oscillator circuit, and the loop-antenna 90 is electronically connected to the IC chip. The high-frequency IC chip 80 and the antenna 90 may be integrally mounted on the insulating rectangular board 100 shown in FIGS. 5 and 6, and the rectangular board 100 may be attached to the object W. The high-frequency IC chip 80 and the antenna 90 may be integrally mounted on an insulating circular board 150 shown in FIG. 7.

The high-frequency IC chip 80 is driven without a battery, more specifically, it is driven by power converted from the data sent from the chargers 7. The high-frequency IC chip 80 sends out information such as the voltage required for charging and remaining battery capacity of the battery built in the object W, through the antenna 90. A high-frequency range of 125 to 250 kHz is used, or frequencies of 13.56 MHz, 27.12 MHz, 40.68 MHz, or 2.45 GHz ISAM band can be used.

As shown in FIG. 5, the rectangular board 100 or the circular board 150 is attached to the object W near the coil 41 of the power receiver, and the coil 41 of the power receiver and the antenna 90 are aligned in the same direction. In the FIG. 5, the two-dot chain lines illustrate the chargers 7 arranged around the object W.

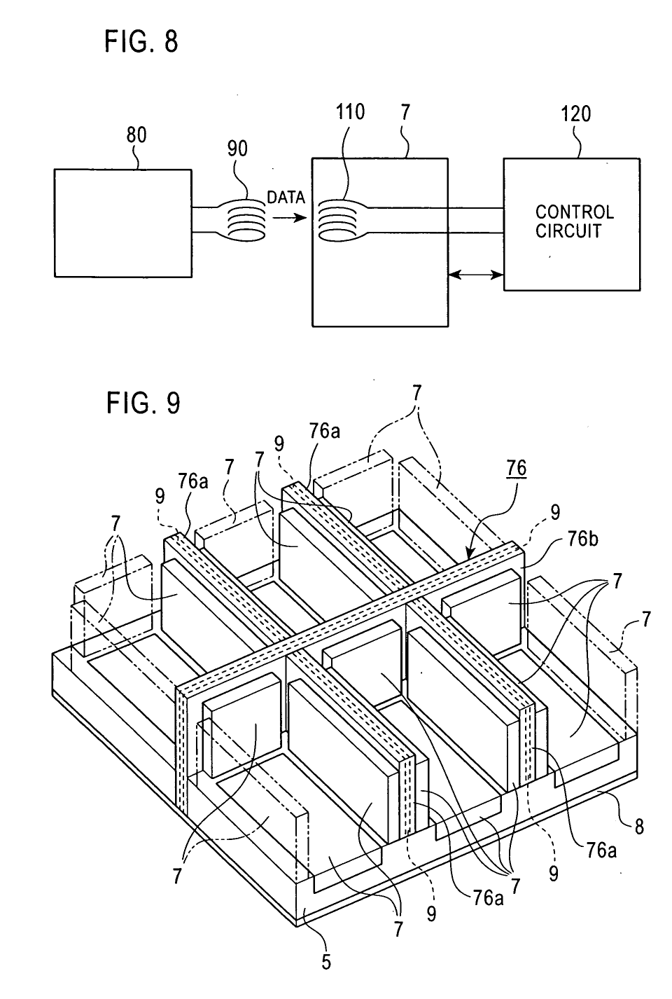

As shown in FIG. 8, each of the chargers 7 has a built-in antenna 110. The antenna 110 receives high-frequency data signals sent from the IC chip 80 through the antenna 90, and is connected to a control circuit 120. The control circuit 120 is arranged at the backside, i.e. the opposite side of the door 3, like an ordinary refrigerator having electrical system circuits at the backside.

The control circuit 120 processes the data signals received by the antenna 110 and drives a charger 7, which outputs electromagnetic waves in the optimal direction in relation to the object W, among the four chargers 7 around the object W. In particular, each of the four chargers 7 around the object W communicates with the high-frequency IC chip 80 in turn at a predetermined interval. A charger 7 that fails to communicate is not used. Therefore, based upon whether or not these four chargers 7 are used, it can be confirmed whether the object W is put in. When more than one charger 7 are in communication with the high-frequency IC chip 80, a charger 7 which shows an optimal communication is used as the charger 7 which is most close to the coil 41 of the power receiver of the object W. The chargers 7 include a means for detecting receiving sensitivity (not shown). The optimal direction of the electromagnetic waves differs depending on the charging condition of the chargers 7, and is determined from various conditions. For example, depending on the high frequency data signals from the IC chip 80; a charger 7 having the coil of the power feeder closest to the coil 41 of the power receiver of the object W is driven, and then charges the object W.

Then, a process for charging objects will now be described according to a second embodiment of the present invention.

When a portable electronic device is equipped with the oscillator circuit 40 for power receiver, the rectifier/smoothing circuit 50, and the current control circuit 60 shown in FIG. 4, the portable electronic device itself is used as the object W. A rectangular board 100 or a circular board 150, having the IC chip 80 and the antenna 90 shown in FIG. 6 or 7, is attached to the object W. The door 4 is opened, and then the object W is put on an arbitrary shelf 5 divided by partitions 6 in the housing 2.

The control circuit 120 controls the chargers 7 around the object W to communicate with the IC chip 80 of the object W in turn at a predetermined interval. The control circuit 120 drives a charger 7 which shows the best receiving sensitivity among the chargers 7 in communication. The control circuit 120 processes data signals and controls the output of the charger 7 driven according to the charging voltage of the object W. The resonance coil 21 of the power feeder shown in FIG. 4 generates a resonance frequency tuned to the object W. The resonance coil 41 of the power receiver of the object W tunes to the resonance frequency from a suitable direction, receives electromagnetic energy in cooperation with the resonance capacitor 42, and then converts it into DC electrical energy. Such voltage is rectified and smoothed by the rectifier/smoothing circuit 50, is adjusted to a voltage suitable for charging by the charge control circuit 60, and then is sent to the secondary battery 70 to charge the secondary battery 70.

When a secondary battery detached from an electronic device such as portable electronic devices is charged, an adapter equipped with the oscillator circuit 40 for the power receiver, the rectifier/smoothing circuit 50, and the current control circuit 60 shown in FIG. 4 is prepared. The adapter is provided with a rectangular board 100 or a circular board 150 having the IC chip 80 and the antenna 90 shown in FIG. 6 or 7. The door is opened, and then the secondary battery with the adapter, as an object W to be charged, is put on an arbitrary shelf 5 divided by partitions 6 in the housing 2. Then, the secondary battery is charged according to the above-described process.

A charging apparatus according to a third embodiment of the present invention will now be described with reference to FIG. 9.

In the charging apparatus of the third embodiment, the arrangement of the partitions is different from that of the first embodiment shown in FIGS. 1 to 4 and the second embodiment shown in FIGS. 5 to 8. Members being the same as those shown in FIGS. 1 to 8 are referred to with the same reference numerals and the description thereof is omitted.

As shown FIG. 9, standing partitions 76 are provided on each shelf 5 in the longitudinal direction, i.e. in the direction of the depth of the housing 2, and in the width direction, orthogonal to the depth of the housing 2.

An object to be charged is put on each space which is formed by partitions 76a in the longitudinal direction and partition 76b in the width direction, or formed by these partitions and side walls 2a of the housing. An optimal charger among the four chargers 7 arranged in various directions charges the object.

In the third embodiment, as shown in FIG. 9, the chargers 7 are arranged in the shelf 5, on the partition 76a, and on the inner face of the side wall of the housing 2 along each of the partitions 76a in the longitudinal direction, and are also arranged on the partition 76b in the width direction and the inner face of the back wall of the housing 2. The chargers 7 arranged on the partition 76b face the door. In FIG. 9, the chargers 7 shown by two-dot chain lines are mounted as in FIG. 2, which are mounted on the inner faces of the side walls 2a and the inner face of the back wall 2b of the housing 2. In the partitions 76a and the partition 76b, shielding bodies 9 shown in FIG. 3 are embedded. When the charging apparatus of the third embodiment is employed in the second embodiment, each of the chargers 7 shown in FIG. 9 has a built-in antenna 110 shown in FIG. 8. By using the charging apparatus according to the third embodiment, the objects can be charged by the same procedures as in the first and second embodiments, and the inner space of the charging apparatus can be effectively used to charge a number of objects.

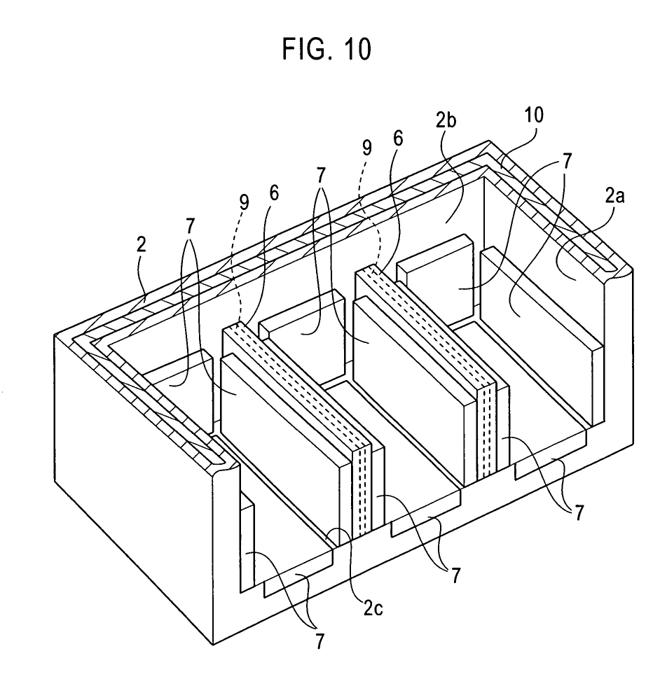

A charging apparatus according to a fourth embodiment of the present invention will now be described with reference to FIG. 10.

The charging apparatus of the fourth embodiment is provided with chargers 7 on the inner face of the bottom 2c in the housing 2 of the first embodiment shown in FIGS. 1 to 4 and the second embodiment shown in FIGS. 5 to 8. Members being the same as those shown in FIGS. 1 to 8 are referred to with the same reference numerals and the description thereof is omitted.

In the fourth embodiment, the inner face of the bottom 2c of the housing 2 is used in place of the shelf 5 and two standing partitions 6 are set on the inner face of the bottom 2c such as shown in FIGS. 2 and 3. The other chargers 7 are mounted on the inner faces of the side walls 2a and the inner face of the back wall 2b which are connecting to the inner face of the bottom 2c as in the first embodiment. When the charging apparatus of the fourth embodiment is employed in the second embodiment, each charger 7 shown in FIG. 10 requires a built-in antenna 110 shown in FIG. 8.

In the charging apparatus according to this configuration, the inner space of the housing 2 can be used more effectively. Using the charging apparatus, not having the partitions 6, a large charger 7 may be mounted on the inner face of the bottom to charge a large electronic device.

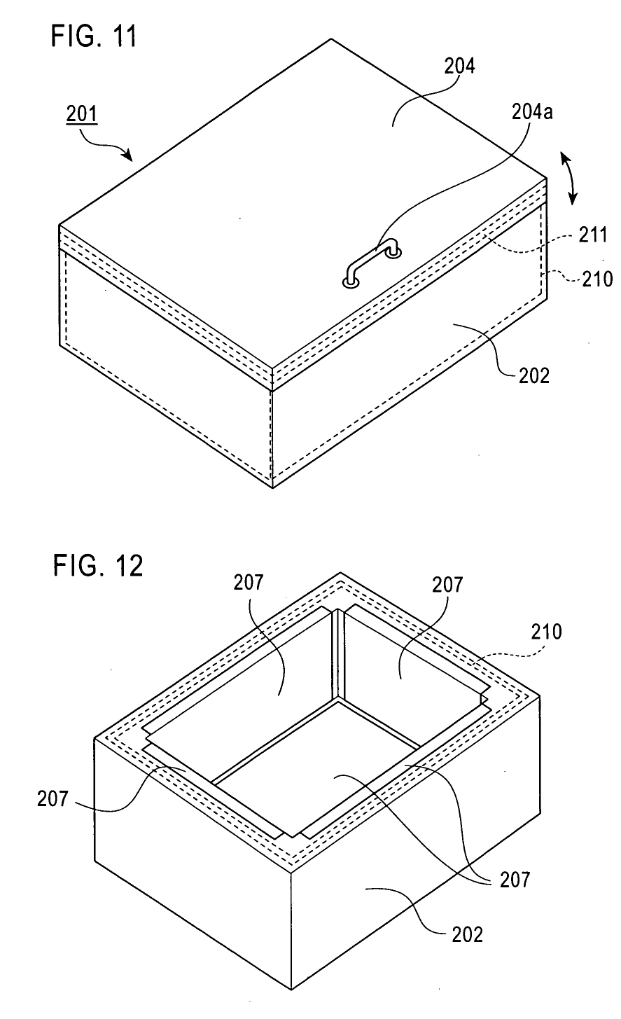

A charging apparatus according to a fifth embodiment of the present invention will now be described with reference to FIGS. 11 and 12.

The charging apparatus of the fifth embodiment has a similar appearance to a one-box type freezer. Members being the same as those shown in FIGS. 1 to 4 are referred to with reference numerals with 200 added to the reference numerals in FIGS. 1 to 4, and the description thereof is omitted.

As shown in FIGS. 11 and 12, the charging apparatus 201 includes a housing 202 which is a case having a door 204 supported by hinges (not shown) at the back side of the housing. The door is openable in the direction shown by an arrow in FIG. 11. In FIG. 11, reference numeral 204a represents a handle, 210 represents shielding bodies embedded in the housing 202, and 211 represents a shielding body embedded in the door 204. The housing 202 has embedded chargers 207 larger than the chargers 7 shown in FIGS. 2 and 3 in the inner faces of the side walls and the inner face of the bottom of the housing 202. These chargers 207 have the same structure as the chargers 7 shown in FIGS. 2, 3, 4, and 8.

The charging apparatus 201 is particularly useful in charging a large object W or in simultaneously charging multiple objects W of medium or small size by merely putting them in the housing 202 at random. Each of the objects W is provided with a rectangular board 100 or a circular board 150 having the IC chip 80 and the antenna 90 shown in FIGS. 6 and 7, before the object W is put in the housing 202.

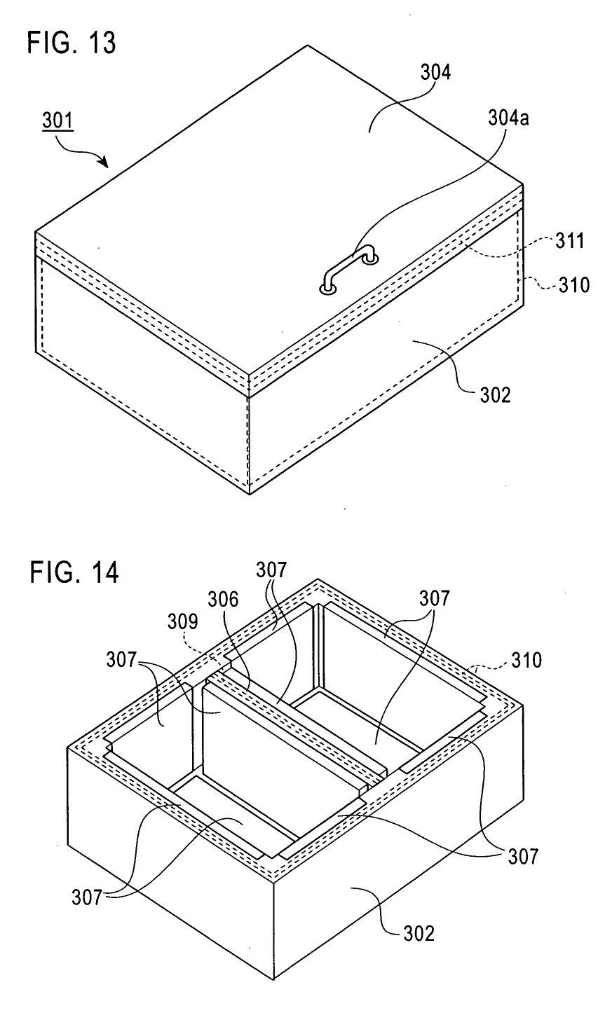

A charging apparatus according to a sixth embodiment of the present invention will now be described with reference to FIGS. 13 and 14.

The charging apparatus of the sixth embodiment includes a housing of a one-box type charging apparatus shown in the fifth embodiment and a partition shown in FIG. 3 in the housing. Members being the same as those shown in FIGS. 1 to 4 are referred to with reference numerals with 300 added to the reference numerals in FIGS. 1 to 4, and the description thereof is omitted.

As shown in FIGS. 13 and 14, the charging apparatus 301 includes a housing 302 which is a case having a door 304 supported by hinges (not shown) at the back side of the housing. The door is openable in the direction shown by an arrow in FIG. 13. In FIG. 13, reference numeral 304a represents a handle, 310 represents shielding bodies embedded in the housing 302, and 311 represents a shielding body embedded in the door 304.

The inner part of the housing 302 is divided into two segments by a standing partition 306. Chargers 307 larger than the chargers 7 shown in FIGS. 2 and 3 are embedded in the inner faces of the side walls and the inner face of the bottom of the housing 302. The partition 306 also has the chargers 307 on both sides. These chargers 307 have the same structure as the chargers 7 shown in FIGS. 2, 3, 4, and 8. In FIG. 14, reference numeral 309 represents a shielding body built in the partition 306.

The charging apparatus 301 is particularly useful in charging an object W of medium size or in simultaneously charging multiple objects W of medium or small size by merely putting them in the housing 202 at random. Each of the objects W is provided with a rectangular board 100 or a circular board 150 having the IC chip 80 and the antenna 90 shown in FIGS. 6 and 7, before the object W is put in the housing 302.

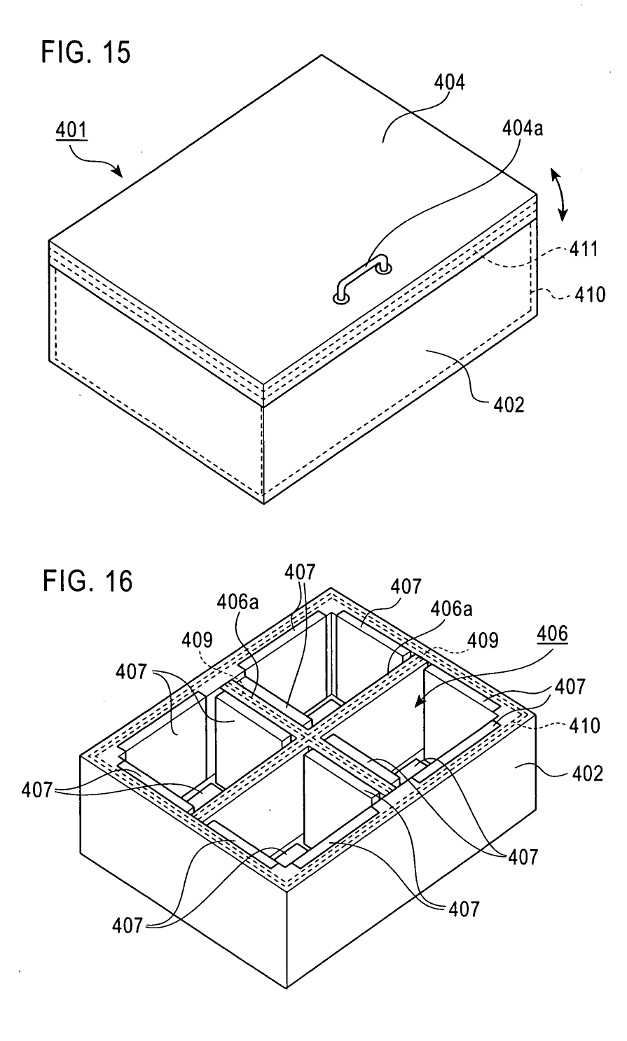

A charging apparatus according to a seventh embodiment of the present invention will now be described with reference to FIGS. 15 and 16.

The charging apparatus of the seventh embodiment includes a housing of a one-box type charging apparatus shown in the fifth embodiment and partitions shown in FIG. 9 for partitioning the inner part of the housing vertically and horizontally. Members being the same as those shown in FIGS. 1 to 4 are referred to with reference numerals with 400 added to the reference numerals in FIGS. 1 to 4, and the description thereof is omitted.

As shown in FIGS. 15 and 16, the charging apparatus 401 includes a housing 402 which is a case having a door 404 supported by hinges (not shown) at the back side of the housing. The door is openable in the direction shown by an arrow in FIG. 15. In FIG. 15, reference numeral 404a represents a handle, 410 represents shielding bodies embedded in the housing 402, and 411 represents a shielding body embedded in the door 404.

The inner part of the housing 402 is divided into four segments by standing partitions 406. The housing 402 has chargers 407 larger than the chargers 7 shown in FIGS. 2 and 3 embedded in the inner faces of the side walls and the inner face of the bottom of the housing 402. The partitions 406 consist of a partition 406a in the longitudinal direction and a partition 406a in the width direction. The chargers 407 are mounted on both sides of the partition 406a in the longitudinal direction. These chargers 407 have the same structure as the chargers 7 shown in FIGS. 2, 3, 4, and 8. In FIG. 16, reference numeral 409 represents shielding bodies built in the partitions 406a and 406b.

The charging apparatus 401 is particularly useful in charging an object W of relatively small size or in simultaneously charging multiple objects W of small size by merely putting them in the housing 202 at random. Each of the objects W is provided with a rectangular board 100 or a circular board 150 having the IC chip 80 and the antenna 90 shown in FIGS. 6 and 7, before the object W is put in the housing 302.

### Industrial Applicability

A charging apparatus according to the present invention includes a housing, a door, and chargers for charging objects to be charged in the housing. Each of the chargers noncontactly supplies electric power by electromagnetic induction from a built-in coil of a power feeder to the object having a built-in coil of a power receiver and a built-in battery.

Since the charging apparatus can easily charge a plurality of objects such as various secondary batteries by merely receiving them in the housing, many chargers exclusively used in secondary batteries for a variety of electronic devices are not needed. Consequently, the number of dedicated chargers is drastically decreased. Therefore, the charging apparatus according to the present invention is very valuable from the recent controversial viewpoint of an effective use of resources.

1. A charging apparatus comprising a housing having an opening at one side; an openable supported door for shutting the opening of the housing; and chargers for charging an object to be charged in the housing, wherein the chargers noncontactly supply electric power by electromagnetic induction from built-in coils of power feeders to said object having a built-in coil of a power receiver and a built-in battery.

2. The charging apparatus according to claim 1, further comprising a first antenna for receiving high-frequency data signals; and a circuit for controlling chargers around the object according to the data signals received by the first antenna so as to drive a charger sending electromagnetic waves to the objects from an optimal direction, wherein the high-frequency data signals are sent from an IC chip having a high-frequency oscillator circuit through second antenna connecting to the IC chip, the IC chip and the second antenna being attached to the objects.

3. The charging apparatus according to claim 1, further comprising a shelf in the housing for receiving the object, wherein the chargers for charging the objects placed on the shelf or on an inner face of a bottom of the housing are provided to the shelf or the housing.

4. The charging apparatus according to claim 2, further comprising a shelf in the housing for receiving the object, wherein the chargers for charging the objects placed on the shelf or on an inner face of a bottom of the housing are provided to the shelf or the housing.

5. The charging apparatus according to claim 3, further comprising a standing partition on said shelf or on the inner face of the bottom of the housing for partitioning the shelf or the inner face of the bottom of the housing into a plurality of spaces, wherein the object is placed in a space partitioned by the partition.

6. The charging apparatus according to claim 4, further comprising a standing partition on said shelf or on the inner face of the bottom of the housing for partitioning the shelf or the inner face of the bottom of the housing into a plurality of spaces, wherein the object is placed in a space partitioned by the partition.

7. The charging apparatus according to claim 5, wherein at least one of the chargers is provided over said partition.

8. The charging apparatus according to claim 6, wherein at least one of the chargers is provided on said partition.

9. The charging apparatus according to claim 1, wherein the housing includes a shielding body for shielding the outside from electromagnetic waves generated by the electromagnetic induction.

10. The charging apparatus according to claim 2, wherein the housing includes a shielding body for shielding the outside from electromagnetic waves generated by the electromagnetic induction.

11. The charging apparatus according to claim 3, wherein said shelf has a shielding body for blocking electromagnetic waves generated by electromagnetic induction below the shelf.

12. The charging apparatus according to claim 4, wherein said shelf has a shielding body for blocking electromagnetic waves generated by electromagnetic induction below the shelf.

13. The charging apparatus according to claim 5, wherein said partition has a shielding body for blocking electromagnetic waves generated by electromagnetic induction.

14. The charging apparatus according to claim 6, wherein said partition has a shielding body for blocking electromagnetic waves generated by electromagnetic induction.

15. The charging apparatus according to claim 1, wherein the object includes a secondary battery detached from an electronic device and an adapter having the built-in coil of the power receiver and attached to the secondary battery.

16. The charging apparatus according to claim 2, wherein the object includes a secondary battery detached from an electronic device and an adapter having the built-in coil of the power receiver and attached to the secondary battery.

17. The charging apparatus according to claim 1, wherein the object is a secondary battery detachable from an electronic device and having the coil of the power receiver.

18. The charging apparatus according to claim 2, wherein the object is a secondary battery detachable from an electronic device and having the coil of the power receiver.

19. The charging apparatus according to claim 1, wherein the object is a portable electronic device.

20. The charging apparatus according to claim 2, wherein the object is a portable electronic device.
